(19) United States
(12) Patent Application Publication
(10) Pub. No.: US 2010/0076927 A1
(43) Pub. Date: Mar. 25, 2010

(54) IMAGE FORMING APPARATUS, INFORMATION PROCESSING SYSTEM, METHOD OF CONTROLLING THE IMAGE FORMING APPARATUS, AND STORAGE MEDIUM

(75) Inventor: Nobuyuki Hirai, Port Washington, NY (US)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/556,989

(22) Filed: Sep. 10, 2009

(30) Foreign Application Priority Data
Sep. 10, 2008 (JP) 2008-232109

(51) Int. Cl. G06F 17/30

(52) U.S. Cl. 707/610; 707/E17.005

(57) ABSTRACT

An image forming apparatus which is capable of reducing a memory thereof and avoiding a file of which actual data is stored from being requested from other apparatuses. An image forming apparatus is connected to a plurality of external apparatuses via a communication line and is capable of synchronizing files with the external apparatuses. When it is determined that a file is a file of which actual data does not need to be stored, and at the same time it is determined that synchronization with all of the external apparatuses is completed, there is deleted the actual data of the file which is determined to be a file of which actual data does not need to be stored.

### BACKGROUND OF THE INVENTION

1. Field of the Invention

The present invention relates to an image forming apparatus which synchronizes files with, for example, a plurality of information processing apparatuses including other image forming apparatuses, an information processing system, a method of controlling the image forming apparatus, and a storage medium storing a program for causing a computer to execute the method.

2. Description of the Related Art

Conventionally, as a system for synchronizing files, there has been proposed e.g. a system that completely synchronizes only file management information over a network of a client/server type, and synchronizes actual data of the file only in a case where the client side selects the same. Such a file synchronization system makes it possible to suppress an increase in memory on the client side (see Japanese Patent Laid-Open Publication No. 2006-236350).

Further, recently, there has been proposed groupware which synchronizes databases between a plurality of apparatuses over a peer-to-peer network.

However, if the method of synchronizing only file management information is applied to a system in which a plurality of information processing apparatuses and image forming apparatuses synchronize files over a peer-to-peer network, there arises the following problem:

For example, there is a case where an information processing apparatus or an image forming apparatus which stores only the file management information is requested of actual data of a file by another apparatus, and in this case, it is not possible to synchronize the actual data.

### SUMMARY OF THE INVENTION

The present invention provides an image forming apparatus which is capable of reducing a memory thereof and avoiding a file of which actual data is stored from being requested from other apparatuses, an information processing system, a method of controlling the image forming apparatus, and a storage medium storing a program for causing a computer to execute the method.

In a first aspect of the present invention, there is provided an image forming apparatus that is connected to a plurality of external apparatuses via a communication line, and is capable of synchronizing files with the external apparatuses, comprising a storage unit configured to store file management information including information on the state of synchronization with the external apparatuses, a first determination unit configured to determine whether or not a file is a file of which actual data does not need to be stored, a second determination unit configured to determine based on the information on the state of synchronization stored in the storage unit whether or not synchronization with all of the external apparatuses is completed, and a first deletion unit configured to be operable when it is determined by the first determination unit that a file is a file of which actual data does not need to be stored, and at the same time it is determined by the second determination unit that synchronization with all of the external apparatuses is completed, to delete the actual data of the file which is determined to be a file of which actual data does not need to be stored.

In a second aspect of the present invention, there is provided an information processing system in which an image forming apparatus and a plurality of external apparatuses are connected via a communication line, and in which the image forming apparatus and the external apparatuses are capable of synchronizing files with each other, wherein the image forming apparatus comprises a storage unit configured to store file management information including information on the state of synchronization with the external apparatuses a first determination unit configured to determine whether or not a file is a file of which actual data does not need to be stored, a second determination unit configured to determine based on the information on the state of synchronization stored in the storage unit whether or not synchronization with all of the external apparatuses is completed, and a first deletion unit configured to be operable when it is determined by the first determination unit that a file is a file of which actual data does not need to be stored, and at the same time it is determined by the second determination unit that synchronization with all of the external apparatuses is completed, to delete the actual data of the file which is determined to be a file of which actual data does not need to be stored.

In a third aspect of the present invention, there is provided a method of controlling an image forming apparatus that is connected to a plurality of external apparatuses via a communication line, and is capable of synchronizing files with the external apparatuses, comprising a first determination step of determining whether or not a file is a file of which actual data does not need to be stored, a second determination step of determining based on the information on the state of synchronization whether or not synchronization with all of the external apparatuses is completed, and a first deletion step of deleting, when it is determined in the first determination step that a file is a file of which actual data does not need to be stored, and at the same time it is determined in the second determination step that synchronization with all of the external apparatuses is completed, the actual data of the file which is determined to be a file of which actual data does not need to be stored.

In a fourth aspect of the present invention, there is provided a computer-readable storage medium storing a program for causing a computer to execute a method of controlling an image forming apparatus that is connected to a plurality of external apparatuses via a communication line, and is capable of synchronizing files with the external apparatuses, wherein the method comprises a first determination step of determining whether or not a file is a file of which actual data does not need to be stored, a second determination step of determining based on the information on the state of synchronization whether or not synchronization with all of the external apparatuses is completed, and a first deletion step of deleting, when it is determined in the first determination step that a file is a file of which actual data does not need to be stored, and at the same time it is determined in the second determination step that synchronization with all of the external apparatuses is completed, the actual data of the file which is determined to be a file of which actual data does not need to be stored.

According to the present invention, only when synchronization is completed with all external apparatuses, it becomes possible to delete actual data which does not need to be stored. This makes it possible to reduce a memory of the image forming apparatus, and prevent a file of which actual data is not stored from being requested from other apparatuses.

The features and advantages of the invention will become more apparent from the following detailed description taken in conjunction with the accompanying drawings.

### BRIEF DESCRIPTION OF THE DRAWINGS

FIG. 1 is a diagram of the system configuration of an information processing system according to an embodiment of the present invention.

FIG. 2 is a block diagram of the basic hardware configuration of an image forming apparatus.

FIG. 3 is a block diagram of the basic hardware configuration of an information processing apparatus.

FIG. 4 is a diagram of an example of file management information stored in a document management section of the image forming apparatus.

FIG. 5 is a diagram of an example of file management information stored in a hard disk of the information processing apparatus.

FIG. 6 is a diagram of an example of a first state of synchronization of the information processing system.

FIG. 7 is a diagram of an example of a second state of synchronization of the information processing system.

FIG. 8 is a diagram of an example of a third state of synchronization of the information processing system.

FIG. 9 is a diagram of an example of a fourth state of synchronization of the information processing system.

FIG. 10 is a diagram of an example of a fifth state of synchronization of the information processing system.

FIG. 11 is a diagram of an example of a sixth state of synchronization of the information processing system.

FIG. 12 is a flowchart of a process executed by the image forming apparatus of the information processing system.

FIG. 13 is a flowchart of an actual data-deleting process executed in a step in FIG. 12.

FIG. 14 is a flowchart of an online-time process executed in a step in FIG. 12.

FIG. 15 is a flowchart of an other-apparatus online state-starting process executed in a step in FIG. 14.

FIG. 16 is a view of an example of a registration screen for registering files to be stored in the image forming apparatus.

### DETAILED DESCRIPTION OF THE EMBODIMENTS

The present invention will now be described in detail below with reference to the accompanying drawings showing embodiments thereof.

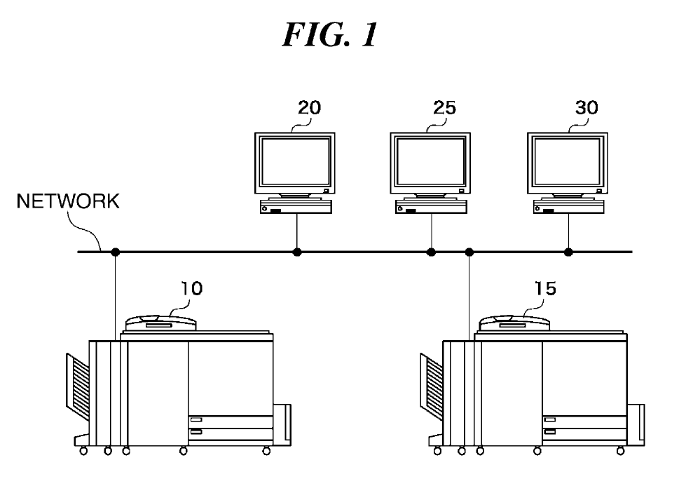

FIG. 1 is a diagram of the system configuration of an information processing system which is an example of an embodiment of the present invention.

In the information processing system of the present embodiment, as shown in FIG. 1, an image forming apparatus 15 as an external apparatus, an information processing apparatus 20, an information processing apparatus 25, and an information processing apparatus 30 are interconnected to an image forming apparatus 10 via a communication line such as a network or the like.

Each of the image forming apparatuses 10 and 15 has a scan function, a print function, and a copy function or the like, and each of the information processing apparatuses 20, 25, and 30 has functions of storing, managing, displaying, editing, and printing various kinds of files.

In the present embodiment, there is carried out processing for synchronizing file management information on files and actual data of files between the image forming apparatuses 10 and 15, between the information processing apparatuses 20, 25 and 30, and between the image forming apparatuses 10 and 15, and the information processing apparatuses 20, 25, and 30.

File management information and actual data are stored in each of the image forming apparatuses 10 and 15, and the information processing apparatuses 20, 25, and 30, and if the file management information is updated in one of the apparatuses, this update is reflected on the other file management information stored in the other apparatuses, which makes it possible to always maintain the synchronized properties of the information.

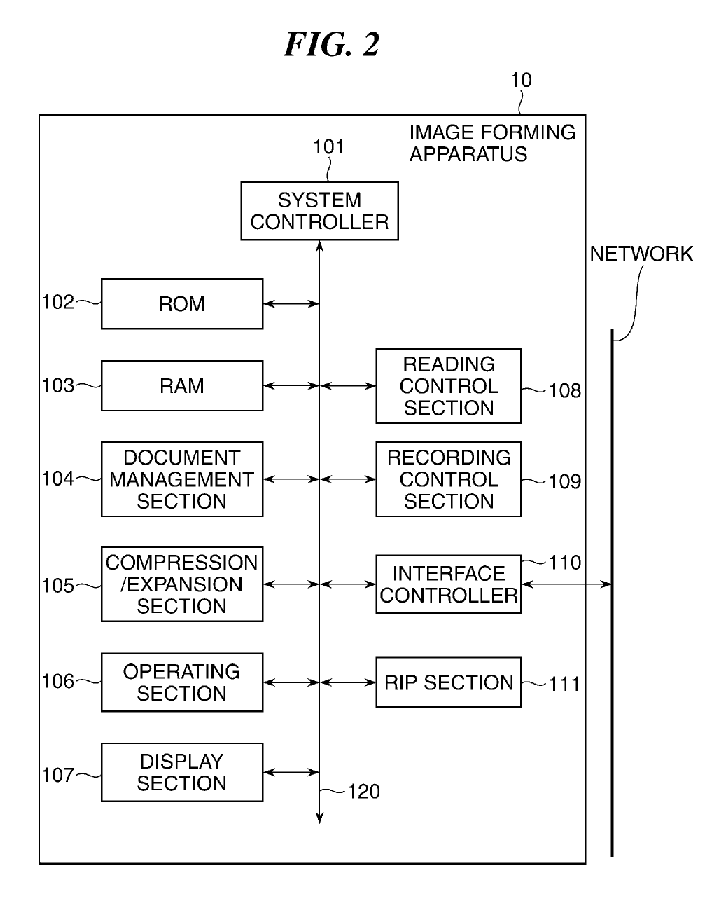

FIG. 2 is a block diagram of the basic hardware configuration of the image forming apparatuses 10 and 15. It should be noted that the basic configuration of the image forming apparatuses 10 and 15 is identical to each other, so that only the image forming apparatus 10 will be described.

As shown in FIG. 2, the image forming apparatus 10 is comprised of a system controller 101, a ROM 102, a RAM 103, a document management section 104, a compression/expansion section 105, an operating section 106, a display section 107, a reading control section 108, a recording control section 109, an interface controller 110, and a RIP section 111. These components 101 to 111 are interconnected via a system bus 120.

The system controller 101 controls the overall operation of the image forming apparatus 10.

The ROM 102 stores a control program for the system controller 101, etc. The control program stored in the ROM 102 is executed by a CPU, not shown, of the system controller 101.

The RAM 103 stores settings registered by an operator and management data on the image forming apparatus 10. Further, the RAM 103 stores temporary variables and the like.

The document management section 104 is implemented by a hard disk or the like memory. The document management section 104 is configured to be capable of storing a plurality of image data items, job data items, job management information items, and so forth. For example, image data items from the reading control section 108 and print job data items input via the interface controller 110 are stored in the document management section 104. In the present embodiment, the document management section 104 also stores the file management information for synchronization with the other image forming apparatus 15 and the information processing apparatuses 20, 25 and 30, and actual data of files.

The compression/expansion section 105 compresses or expands image data. More specifically, the compression/expansion section 105 performs processing, such as compression of image data before storing the same in the document management section 104, and inversely, expansion of compressed image data stored in the document management section 104 into uncompressed image data before reading out the same, as required.

Further, it is widely known to compress data by JPEG, JBIG, or the like, before transferring the data over a network, and when such compressed data is received by the image forming apparatus 10 via the network, the compression/expansion section 105 decompresses (expands) the compressed data.

The operating section 106 is comprised of various kinds of keys and the like with which the operator carries out various input operations.

The display section 107 is implemented e.g. by an LCD or an LED. The display section 107 performs various kinds of displays or voice notifications. If the resolution of the display section 107 is high enough, it is also possible to preview image data stored in the document management section 104 on the display section 107 and print out the same after the check preview.

The reading control section 108 includes an image sensor, such as a CCD, and an image processor.

The reading control section 108 optically reads an image of an original, converts optically read data of the image into electrical image data, and performs various kinds of image processing, such as color processing, binarization processing, and halftone processing, on the electrical image data to thereby generate high-definition image data.

The reading control section 108 is configured to be capable of executing either or both of the ADF method in which originals placed on an ADF (Automatic Document Feeder) are read by feeding one by one and the platen method in which an original placed on an original platen glass is read without being moved.

The recording control section 109 is implemented by a laser printer or an inkjet printer. The recording control section 109 performs various kinds of image processing, such as smoothing and recording density correction, on image data to be recorded on a recording sheet, to thereby convert the image data into high-definition image data, followed by outputting the high-definition image data onto a recording sheet.

The interface controller 110 transmits and receives image data, apparatus information, etc. to and from the other image forming apparatus 15 and the information processing apparatuses 20, 25, and 30, which are interconnected e.g. via a communication line such as a network or the like. In the present embodiment, the interface controller 110 transmits and receives file management information and actual data required to perform synchronization of files.

The RIP (Raster Image Processing) section 111 performs RIP on PDL data input via the interface controller 110. Further, the RIP section 111 is also capable of storing intermediate data of image data generated by the RIP or print ready data (bitmap data for printing or compressed data of the bitmap data), as required, in the document management section 104 again.

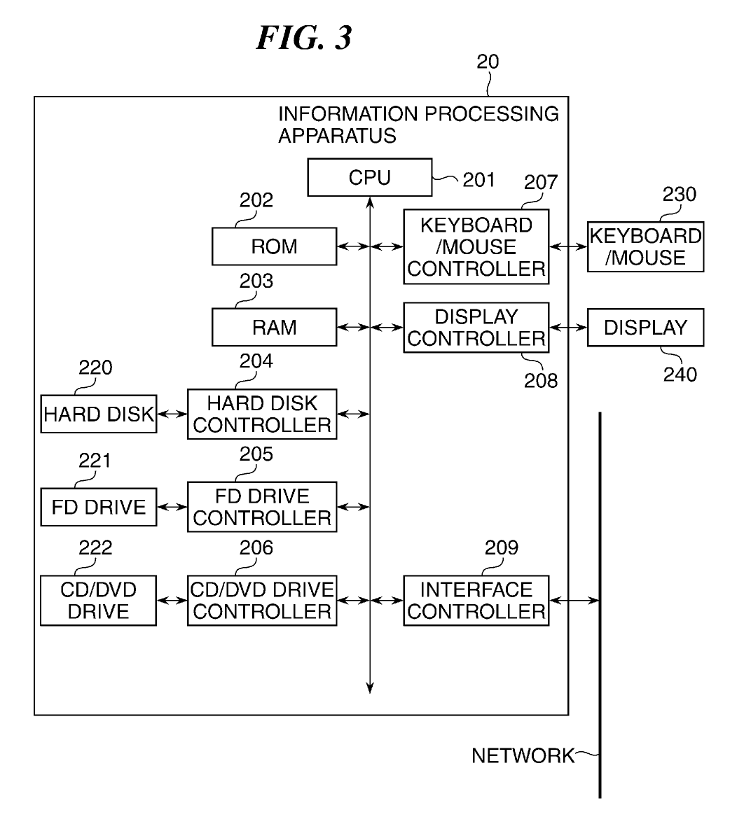

FIG. 3 is a block diagram of the basic hardware configuration of the information processing apparatuses 20, 25, and 30. It should be noted that the basic configuration of each of the information processing apparatuses 20, 25, and 30 is identical, so that the basic configuration will be described only on the information processing apparatus 20.

As shown in FIG. 3, the information processing apparatus 20 is comprised of a CPU 201, a ROM 202, a RAM 203, and a hard disk controller 204. The information processing apparatus 20 further includes an FD drive controller 205, a CD/DVD drive controller 206, a keyboard/mouse controller 207, a display controller 208, and an interface controller 209.

The CPU 201 controls the overall operation of the information processing apparatus 20 according to a program stored in the ROM 202, the RAM 203, or a hard disk 220 or according to a program read out from an FD drive 221 or a CD/DVD drive 222.

The ROM 202 stores the control program executed by the CPU 201 and the like.

The RAM 203 temporarily stores programs and image data so as to enable the information processing apparatus 20 to perform high-speed processing.

The hard disk controller 204 controls the hard disk 220 which stores an OS, various kinds of application software programs, and image data etc. The operating system, various kinds of application software programs, and driver software programs are installed in the hard disk 220, and files, image data, etc. are stored therein.

In general, the application software programs and the driver software programs are installed into the hard disk 220 from other computer-readable media storing the programs e.g. via the FD drive 221 or the CD/DVD drive 222. Alternatively, it is also possible to download the application software programs and the driver software programs via the interface controller 209 and install these into the hard disk 220. In the present embodiment, the hard disk 220 file management also stores information for synchronization with the image forming apparatuses 10 and 15 and the other information processing apparatuses 25 and 30, and actual data of files.

The FD drive controller 205 controls the FD drive 221. The CD/DVD drive controller 206 controls the CD/DVD drive 222. The keyboard/mouse controller 207 controls a keyboard/mouse 230 used by an operator as an instruction input unit for inputting instructions. The display controller 208 controls a display 240 for performing various kinds of displays for the operator.

The interface controller 209 is provided for communication with each of the image forming apparatuses 10 and 15, and the other information processing apparatuses 25 and 30, which are connected to the information processing apparatus 20 e.g. via a communication line of the network. In the present embodiment, the interface controller 209 transmits and receives file management information and actual data required to synchronize files.

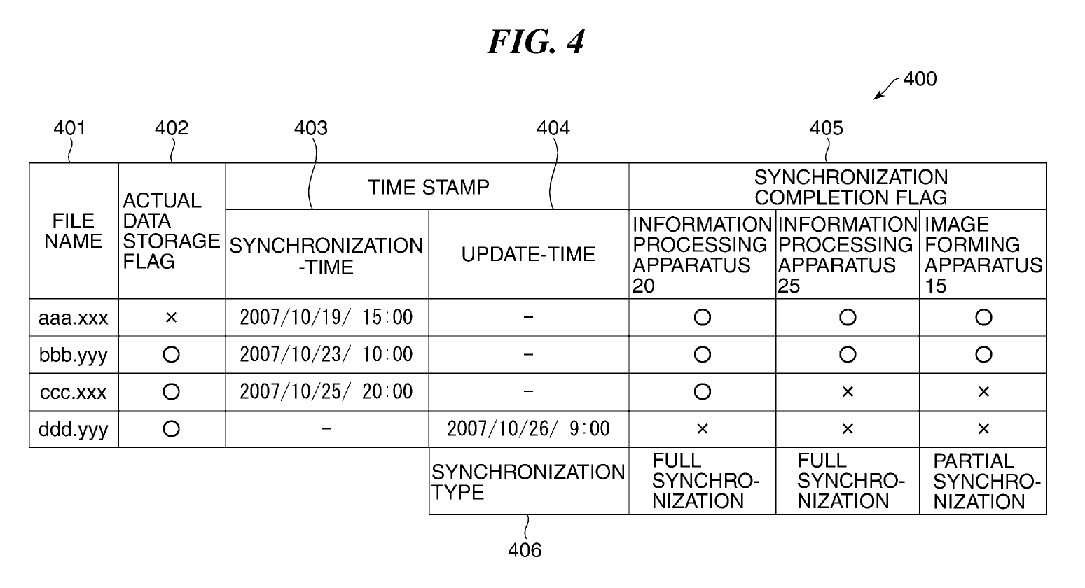

FIG. 4 is a diagram of an example of file management information 400 stored in the document management section 104 of the image forming apparatus 10. It should be noted that similar file management information is also stored in the document management section 104 of the image forming apparatus 15.

The file management information 400 stores information on the state of synchronization with the other image forming apparatus 15 and the information processing apparatuses 20, 25, and 30, and the stored information is updated whenever the state of synchronization is changed.

A file name 401 indicates a file name of an object file. An actual data storage flag 402 indicates whether or not the image forming apparatus 10 stores the actual data of the object file.

A synchronization-time time stamp 403 indicates acquired time stamp information on an object file when the object file is synchronized. An update-time time stamp 404 indicates time stamp information on a file updated after being synchronized or on a newly created file. The time stamp information is updated/created when a synchronized file is updated or when a file is newly created in the image forming apparatus 10, and is maintained until the synchronization is completed.

A synchronization completion flag 405 indicates a state of synchronization of each file between the image forming apparatus and each of the other image forming apparatus 15, and the information processing apparatuses 20, 25, and 30. A synchronization type 406 indicates what type of synchronization can be performed by each of the image forming apparatus 15, the information processing apparatuses 20, 25, and 30.

In the present embodiment, the synchronization types include two types: full synchronization in which file management information on all files and all actual data of the files are stored, and partial synchronization in which file management information on all files is stored, but actual data of only some of the files is stored. In the present embodiment, it is assumed that the information processing apparatuses 20, 25, and 30 support the full synchronization, and the image forming apparatuses 10 and 15 support the partial synchronization.

Further, in the present embodiment, for the partial synchronization, the image forming apparatuses 10 and 15 stores not only file management information on files having an extension of yyy but also actual data of the files, since the files having the extension of yyy have a file format which can be processed by each of the image forming apparatuses 10 and 15 alone.

On the other hand, a file having an extension of xxx has a file format which cannot be processed by each of the image forming apparatuses 10 and 15 alone, and hence, if the synchronization with all of the other apparatuses is completed, the actual data of files having the extension of xxx is deleted. The image forming apparatuses 10 and 15 may store information indicative of the types of file formats which can be processed by the apparatuses or the types of file formats which cannot be processed by the apparatuses, in the document management section 104.

With this configuration, it is possible, for example, to delete a file which cannot be processed by each of the image forming apparatuses 10 and 15 alone, and this makes it possible to reduce the memory of the document management section 104.

Further, as for files of which actual data is to be stored, extensions thereof may be registered in advance in the image forming apparatuses 10 and 15, or may be registered or changed by the operator. A process for registering or changing an extension by the operator will be described hereinafter.

Though not shown in FIG. 4, respective items of synchronization completion flags 405 and a synchronization type 406 in association with the information processing apparatus 30 are assumed to be created in the file management information 400, as will be described hereinafter according to a change in the state of synchronization occurring with online connection of the file management information 400. In general, when an information processing apparatus or image forming apparatus is further added as an apparatus for synchronization, items associated with the additional apparatus are added to the file management information 400.

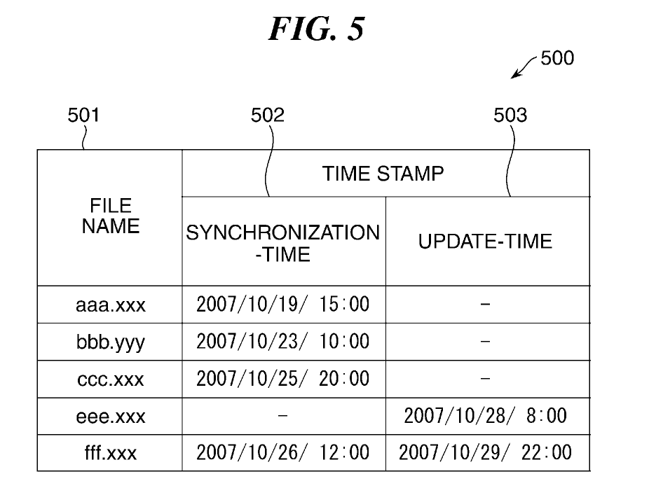

FIG. 5 is a diagram of an example of file management information 500 stored in the hard disk 220 of the information processing apparatus 20. It should be noted that as for the information processing apparatuses 25 and 30, similar file management information is also stored in the hard disk 220 thereof.

The file management information 500 stores management information on the files which are stored in the information processing apparatus 20, and the information is updated whenever the state of synchronization is changed.

A file name 501 indicates a file name of an object file. A synchronization-time time stamp 502 indicate acquired time stamp information on an object file when the object file is synchronized. An update-time time stamp 503 indicates time stamp information on a file updated after being synchronized or on a newly created file. The time stamp information is updated/created when a synchronized file is updated and when a file is newly created in the information processing apparatus 20, and is maintained until the synchronization is completed.

In the present embodiment, the information processing apparatus 20 is configured to be capable of performing the full synchronization, so that it is assumed that information corresponding to the actual data storage flags 402 and the synchronization completion flags 405 illustrated in FIG. 4 are not stored. Of course, the information processing apparatus 20 may be also configured to store these flags and perform the more detailed management.

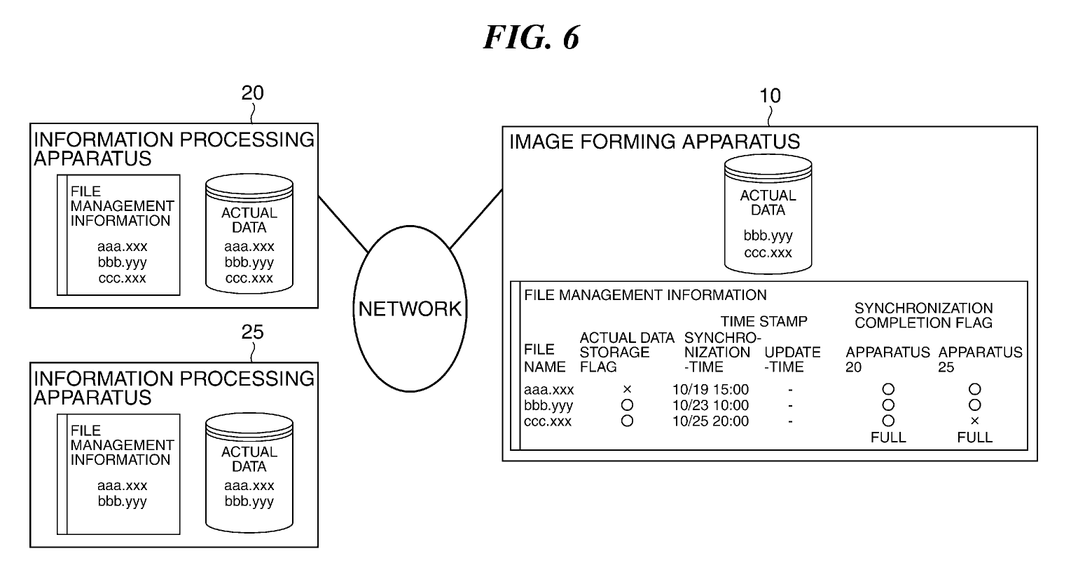

FIG. 6 is a diagram of an example of a first state of synchronization of the information processing system of the present embodiment.

In the first state of synchronization, the information processing apparatus 20 and the image forming apparatus 10 are online connected, and have been synchronized. On the other hand, the information processing apparatus 25 was synchronized with the image forming apparatus 10 before, but at this time point, the information processing apparatus 25 is offline, and a file ccc.xxx has not been synchronized between them.

The image forming apparatus 10 has been synchronized with the information processing apparatus 20, and hence, the image forming apparatus 10 does not store the actual data of a file aaa.xxx. However, the image forming apparatus 10 has not been synchronized with the information processing apparatus 25, and hence the image forming apparatus 10 stores actual data as well of a file ccc.xxx.

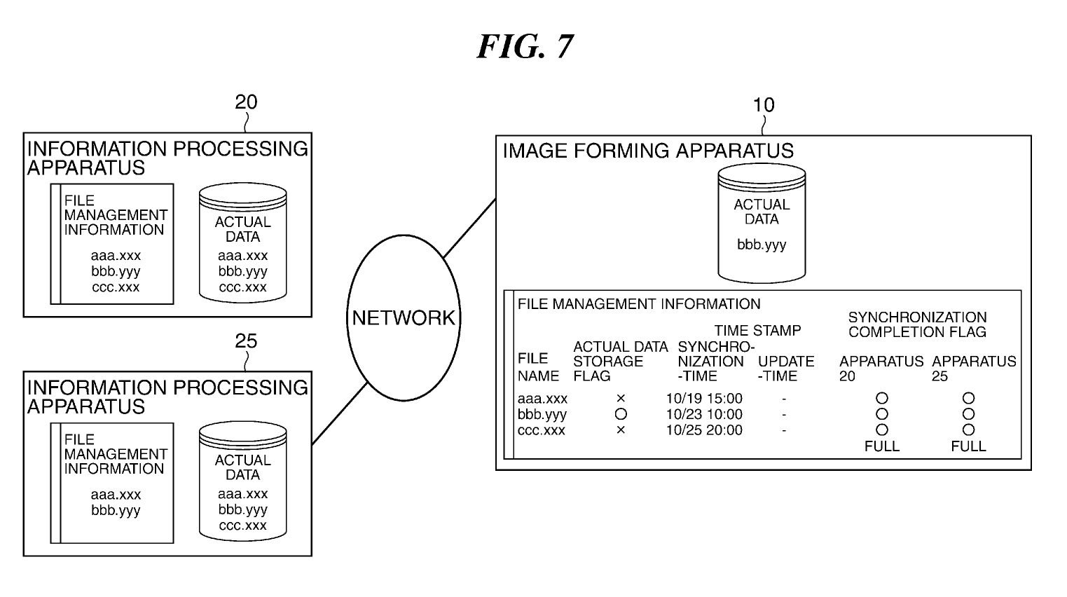

FIG. 7 is a diagram of an example of a second state of synchronization of the information processing system of the present embodiment.

The second state of synchronization is changed from the first state of synchronization in that the information processing apparatus 20 becomes offline to be disconnected from the image forming apparatus 10, and then, the information processing apparatus 25 becomes online connected to the image forming apparatus 10, and has been synchronized with the same.

When the information processing apparatus 25 is online connected, the image forming apparatus 10 acquires the file management information from the information processing apparatus 25. The image forming apparatus 10 determines whether or not the file ccc.xxx exists in the information processing apparatus 25. If the image forming apparatus 10 determines that the file ccc.xxx does not exist, the image forming apparatus 10 transmits the file management information on the ccc.xxx and the actual data of the same to the information processing apparatus 25, and updates the synchronization completion flags 405 associated with the information processing apparatus 25.

Since the file ccc.xxx has been synchronized between the image forming apparatus 10 and all of the other apparatuses for the full synchronization (the information processing apparatuses 20 and 25), the image forming apparatus 10 deletes the actual data of the file ccc.xxx from the document management section 104, and updates the associated actual data storage flag 402.

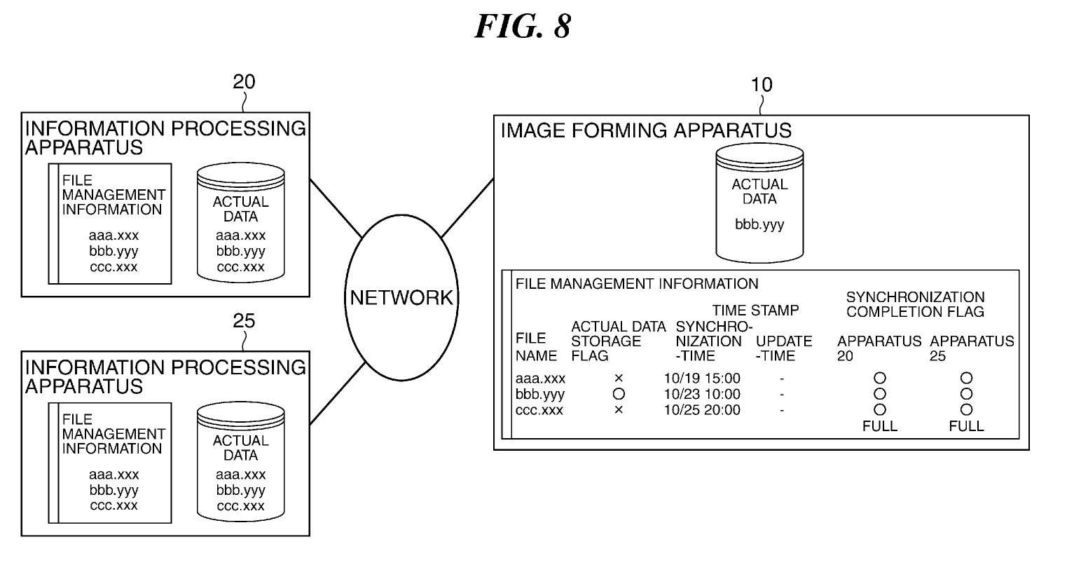

FIG. 8 is a diagram of an example of a third state of synchronization of the information processing system of the present embodiment.

In the third state of synchronization, the information processing apparatuses 20 and 25, and the image forming apparatus 10 are online connected, and have been synchronized. The third state of synchronization is changed from the second state of synchronization in that the information processing apparatus 20 becomes online connected to the image forming apparatus 10.

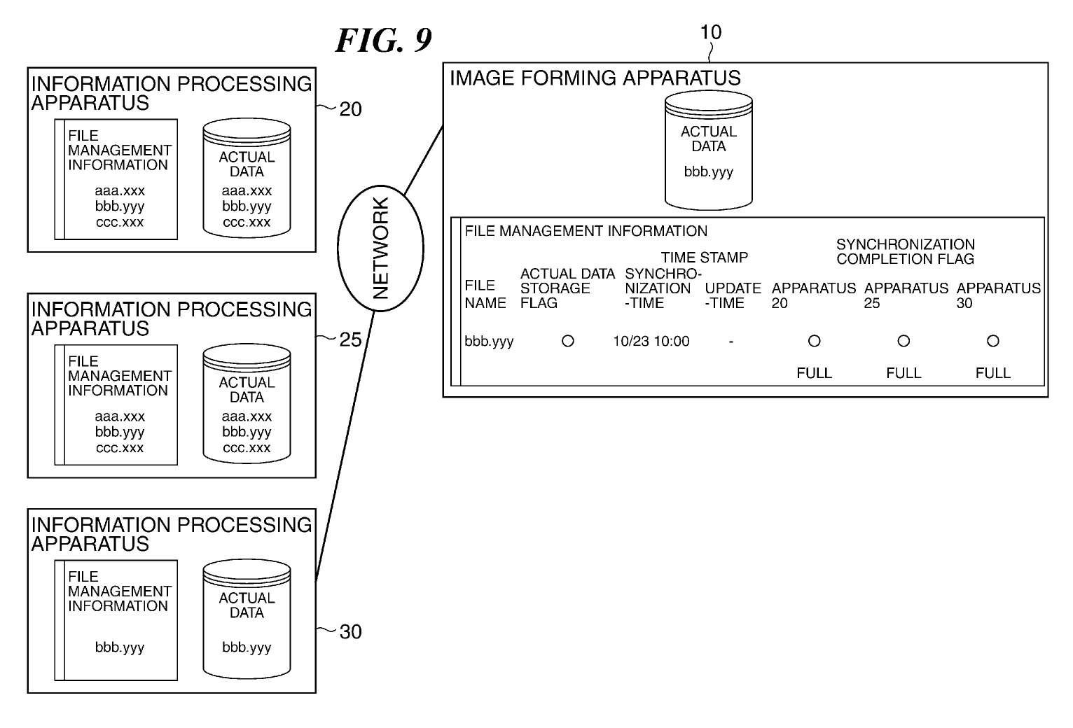

FIG. 9 is a diagram of an example of a fourth state of synchronization of the information processing system of the present embodiment.

The fourth state of synchronization is changed from the third state of synchronization in that both of the information processing apparatuses 20 and 25 become offline to be disconnected from the image forming apparatus 10, and then the information processing apparatus 30 is newly online connected to the image forming apparatus 10 and has been synchronized with the same.

When the information processing apparatus 30 is online connected, the image forming apparatus 10 acquires the file management information from the information processing apparatus 30. Then, the image forming apparatus 10 determines whether or not the information processing apparatus 30 is adapted to perform the full synchronization. If the image forming apparatus 10 determines that the information processing apparatus 30 is adapted to perform the full synchronization, the image forming apparatus 10 determines whether or not any other apparatus adapted to perform the full synchronization is online connected.

If the image forming apparatus 10 determines that no other apparatus adapted to perform the full synchronization is connected, and at the same time there are no synchronized files in the information processing apparatus 30, the image forming apparatus 10 leaves only the file management information on the file bbb.yyy of which the actual data is stored, and deletes the file management information on the files aaa.xxx and ccc.xxx. Thereafter, the image forming apparatus 10 transmits the file management information and the actual data of the file bbb.yyy having a file format which can be processed by the image forming apparatus 10 itself to the information processing apparatus 30, and creates and stores synchronization completion flags 405 associated with the information processing apparatus 30.

By performing the above-described processing, it is possible to prevent the image forming apparatus 10 from transmitting information on files of which actual data is not stored, which makes it possible to avoid the problem that the files of which actual data is not stored are requested.

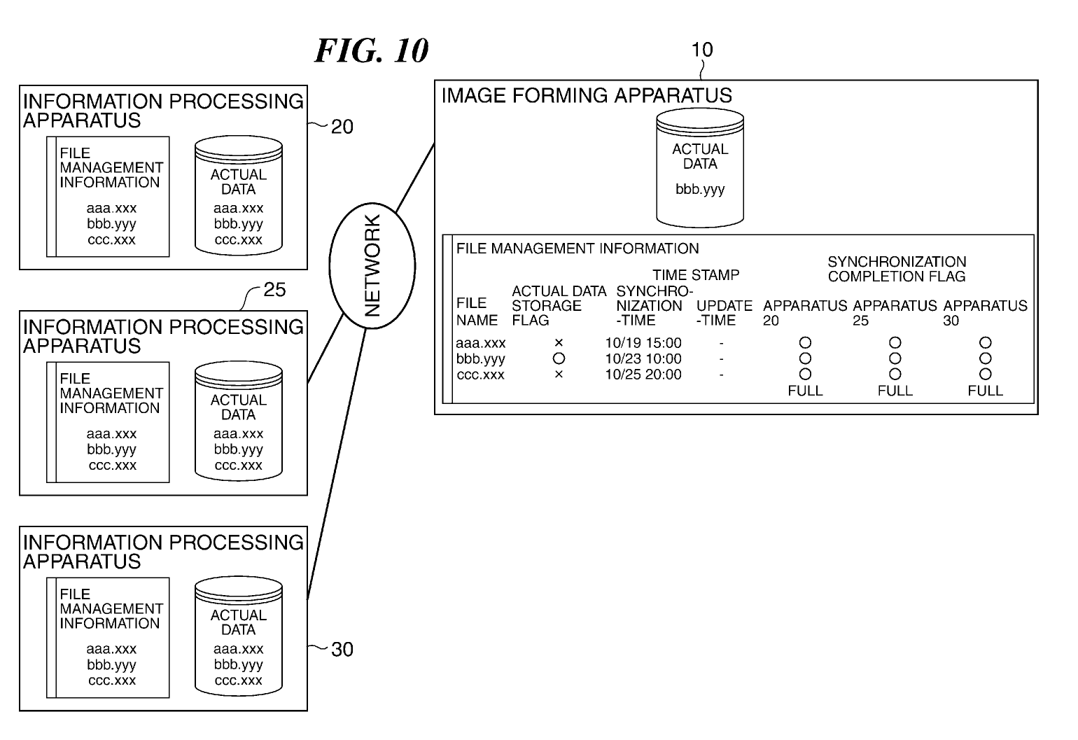

FIG. 10 is a diagram of an example of a fifth state of synchronization of the information processing system of the present embodiment.

The fifth state of synchronization is changed from the third state of synchronization in that the information processing apparatuses 20 becomes offline to be disconnected from the image forming apparatus 10, and then the information processing apparatus 30 is newly online connected to the image forming apparatus 10 and has been synchronized.

When the information processing apparatus 30 is online connected, the image forming apparatus 10 acquires the file management information from the information processing apparatus 30. Then, the image forming apparatus 10 determines whether or not the information processing apparatus 30 is adapted to perform the full synchronization. If the image forming apparatus 10 determines that the information processing apparatus 30 is adapted to perform the full synchronization, the image forming apparatus 10 determines whether or not any other apparatus adapted to perform the full synchronization is online connected.

In this case, since it is determined that the information processing apparatus 25 adapted to perform the full synchronization is online connected, the image forming apparatus 10 waits without performing synchronization until synchronization between the information processing apparatus 25 and the information processing apparatus 30 is completed. After the synchronization between the information processing apparatus 25 and the information processing apparatus 30 is completed, the image forming apparatus 10 acquires the file management information from the information processing apparatus 30, and creates and stores synchronization completion flags 405 associated with the information processing apparatus 30.

By performing the above-described processing, it is possible to prevent the image forming apparatus 10 from deleting the stored file management information, which makes it possible to provide a more user-friendly information processing system.

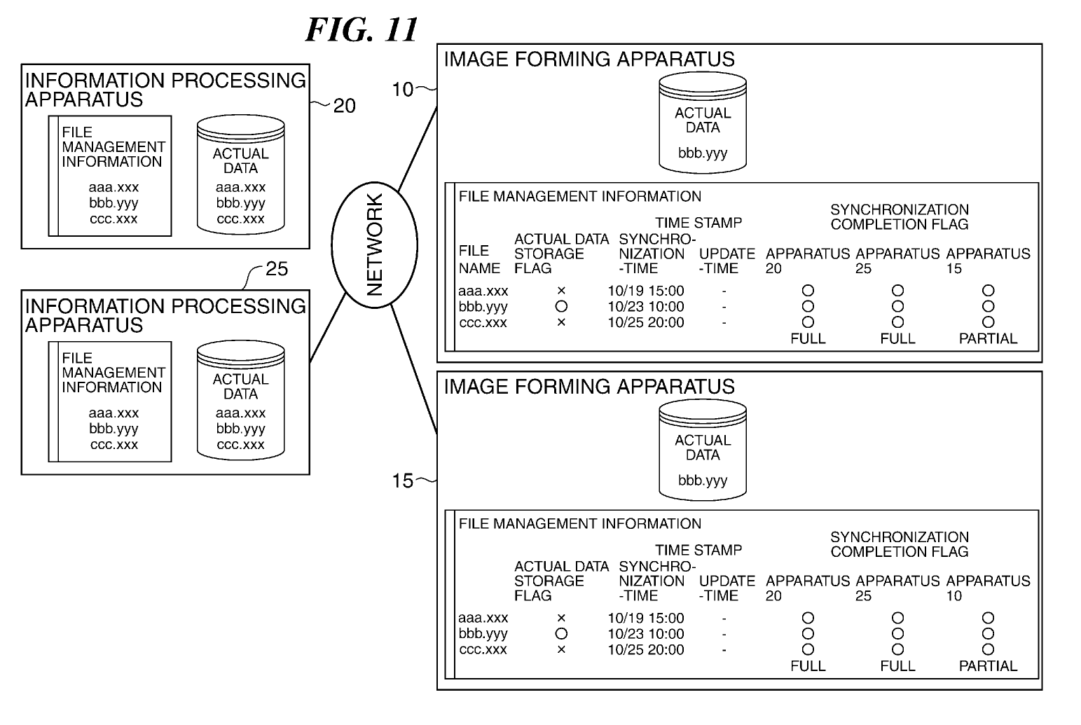

FIG. 11 is a diagram of an example of a sixth state of synchronization of the information processing system of the present embodiment.

The sixth state of synchronization is changed from the third state of synchronization in that the information processing apparatuses 20 becomes offline to be disconnected from the image forming apparatus 10, and then, the image forming apparatus 15 is newly online connected to the image forming apparatus 10 and has been synchronized.

When the image forming apparatus 15 is online connected, the image forming apparatus 10 acquires the file management information from the image forming apparatus 15. Then, the image forming apparatus 10 determines whether or not the image forming apparatus 15 is adapted to perform the partial synchronization. If the image forming apparatus 10 determines that the image forming apparatus 15 is adapted to perform the partial synchronization, the image forming apparatus 10 completes synchronization with the image forming apparatus 15.

For example, if the image forming apparatus 15 is a new apparatus that is online connected to the image forming apparatus 10, the image forming apparatus 10 transmits the file management information 400 on all files and stored actual data to the image forming apparatus 15. Thereafter, the image forming apparatus 10 creates and stores synchronization completion flags 405 associated with the image forming apparatus 15.

On the other hand, the image forming apparatus 15 creates file management information 400 in the document management section 104 thereof based on the file management information 400 and the actual data received from the image forming apparatus 10.

By performing the above-described processing, it becomes possible to effectively exchange the file management information. Further, it also becomes possible to store the synchronization information on the information processing apparatuses 20 in the offline state in the image forming apparatus 15, which makes it possible to provide a more user-friendly synchronization system.

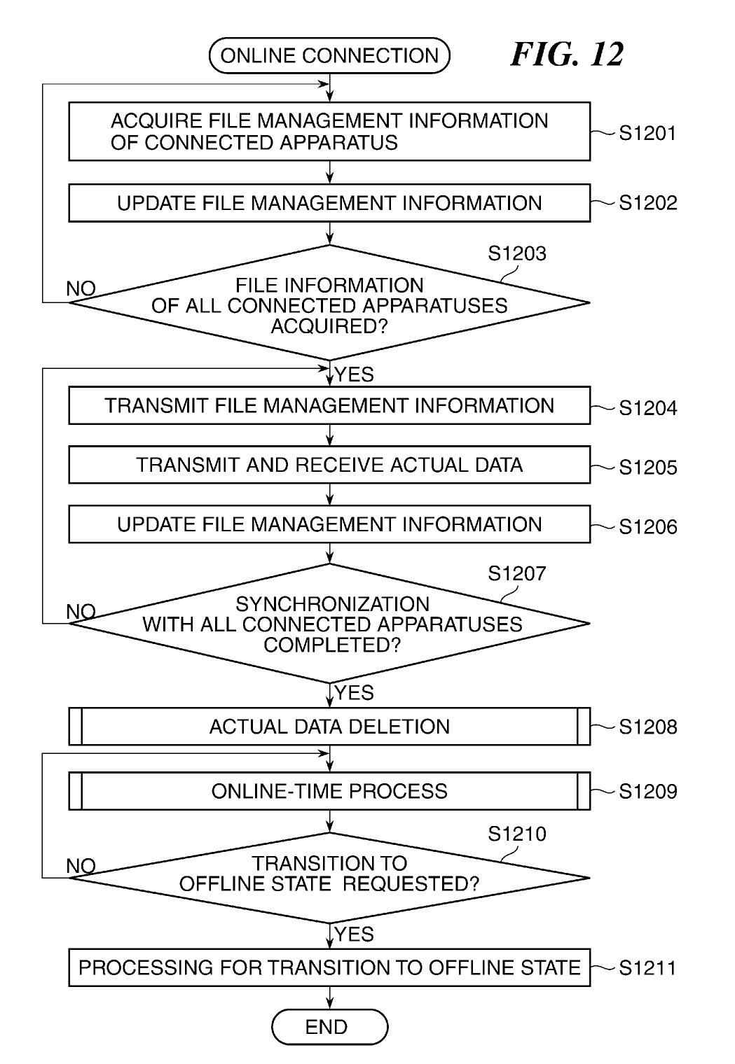

Next, a description will be given of a process executed by the image forming apparatus 10 in the information processing system of the present embodiment with reference to FIG. 12. It should be noted that processing in steps of the process in FIG. 12 is executed by the CPU of the system controller 101, by loading a program therefor stored in the ROM 102 or the like of the image forming apparatus 10 into the RAM 103.

In a step S1201, the system controller 101 acquires items of the file management information 400 and 500 from the other image forming apparatus 15, the information processing apparatuses 20, 25, and 30, which are online connected thereto via the network, and the process proceeds to a step S1202.

In the step S1202, the system controller 101 updates the file management information 400 stored in the document management section 104 based on the items of the file management information 400 and 500 acquired in the step S1201, and the process proceeds to a step S1203.

In the step S1203, the system controller 101 determines whether or not the file management information is acquired from all of the apparatuses 15, 20, 25, and 30, which are online connected via the network. If the system controller 101 determines that the file management information is acquired from all of the apparatuses 15, 20, 25, and 30, the process proceeds to a step S1204, whereas if not, the process returns to the step S1201.

In the step S1204, the system controller 101 transmits the file management information 400 stored in the document management section 104 of the image forming apparatus 10 to the other image forming apparatus 15 and the information processing apparatuses 20, 25, and 30, and the process proceeds to a step S1205.

In the step S1205, the system controller 101 transmits and receives actual data of files required to be synchronized to and from the other image forming apparatus 15 and the information processing apparatuses 20, 25, and 30, and the process proceeds to a step S1206.

In the step S1206, the system controller 101 updates the file management information 400 stored in the document management section 104, and the process proceeds to a step S1207.

In the step S1207, the system controller 101 determines whether or not the synchronization with all of the apparatuses 15, 20, 25, and 30, which are online connected via the network, has been completed. Then, if the system controller 101 determines that there is an apparatus which has not been synchronized, the process returns to the step S1204, whereas if the synchronization with all of the apparatuses 15, 20, 25, and 30 has been completed, the process proceeds to a step S1208.

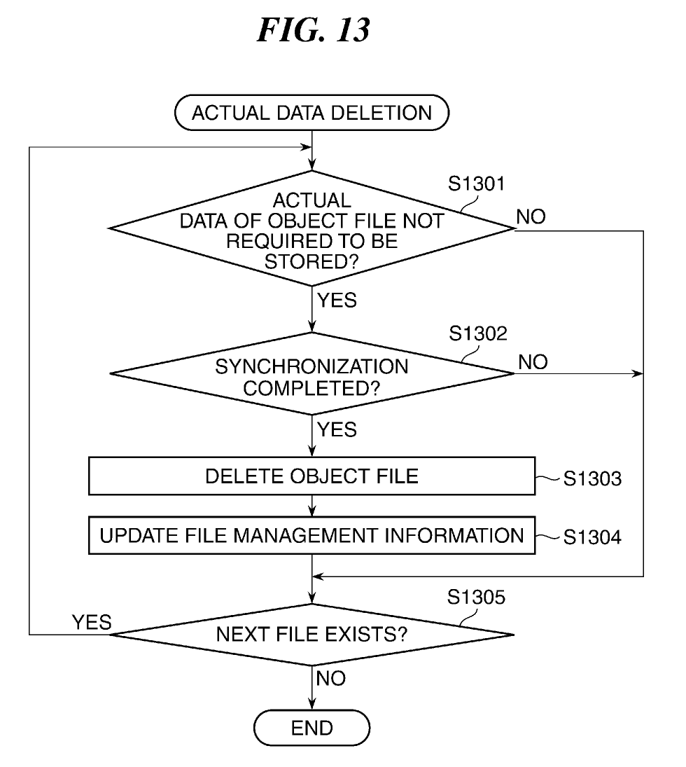

In the step S1208, the system controller 101 carries out an actual data-deleting process, and then the process proceeds to a step S1209. Details of the actual data-deleting process in this step will be described hereinafter in FIG. 13.

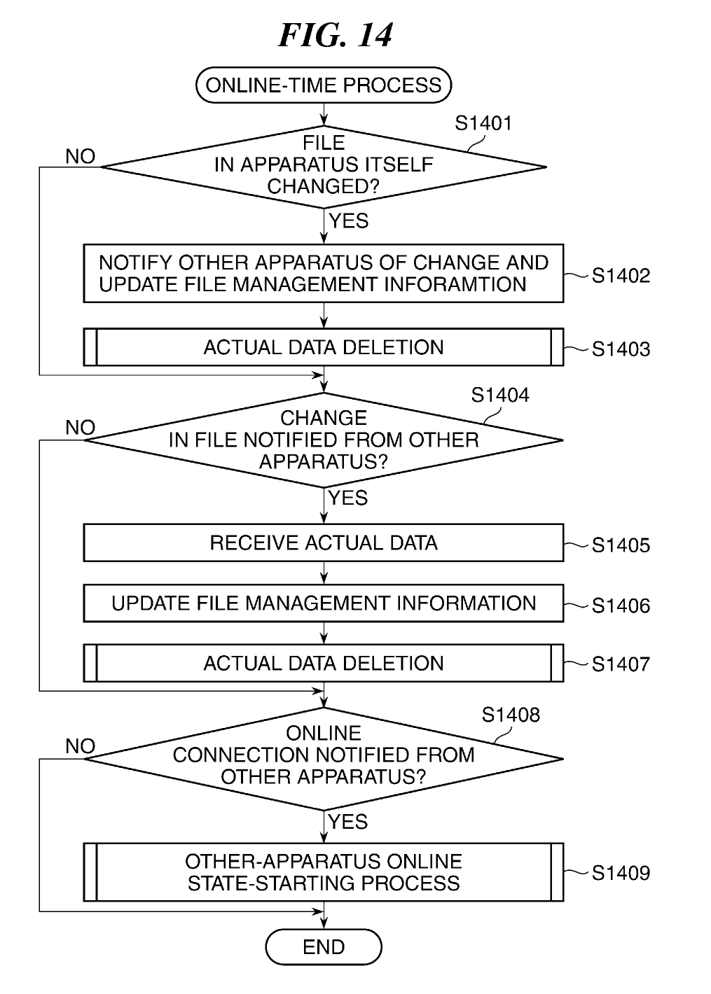

In the step S1209, the system controller 101 carries out an online-time process, and the process proceeds to a step S1210. Details of the online-time process in this step will be described hereinafter in FIG. 14.

In the step S1210, the system controller 101 determines whether or not there is a request for switching to the offline state in the image forming apparatus 10. If there is not a request for transition to the offline state, the process returns to the step S1209, whereas if there is a request for transition to the offline state, the process proceeds to a step S1211.

In the step S1211, the system controller 101 carries out an offline transition process, followed by terminating the present process.

Next, a description will be given of the actual data-deleting process executed in the step S1208 in FIG. 12 with reference to FIG. 13.

First, in a step S1301, the system controller 101 determines whether or not the object file is a file of which actual data does not need to be stored. In this determination, for example, a file which cannot be processed by the image forming apparatus is determined to be a file of which actual data does not need to be stored. Then, if the system controller 101 determines that the file is a file of which actual data does not need to be stored, the process proceeds to a step S1302, whereas if the system controller 101 determines that the file is not a file of which actual data does not need to be stored, i.e. it is a file of which actual data needs to be stored, the process proceeds to a step S1305. In the present embodiment, a file having an extension of xxx is determined to be a file read data of which does not need to be stored.

In the step S1302, the system controller 101 determines whether or not the object file has been synchronized between the image forming apparatus 10 and all of the apparatuses 20, 25 and 30 which are adapted to perform the full synchronization. This can be determined by checking the synchronization completion flags 405 in the file management information 400 stored in the document management section 104. Then, if the system controller 101 determines that the object file has been synchronized between the image forming apparatus 10 and all of the apparatuses 20, 25, and 30, the process proceeds to a step S1303, whereas if not, the process proceeds to a step S1305.

In the step S1303, the system controller 101 deletes the actual data of the object file from the document management section 104, and the process proceeds to a step S1304.

In the step S1304, the system controller 101 changes the actual data storage flag 402 associated with the object file in the file management information 400 to a value indicative of the state in which the actual data is not stored, and then the process proceeds to the step S1305.

In the step S1305, the system controller 101 determines whether or not there is a next file. If there is a next file, the process returns to the step S1301, whereas if not, the process is immediately terminated.

Next, a description will be given of an example of the online-time process executed in the step S1209 in FIG. 12 with reference to FIG. 14.

First, in a step S1401, the system controller 101 determines whether or not there is any change in files in the image forming apparatus 10, such as update, addition, or deletion of a file. Then, if there is any change in files, the process proceeds to a step S1402, whereas if not, the process proceeds to a step S1404.

In the step S1402, the system controller 101 notifies the other image forming apparatus 15 and the information processing apparatuses 20, 25, and 30 of the change, updates the associated item(s) of the file management information 400, and the process proceeds to a step S1403.

In the step S1403, the system controller 101 executes the actual data-deleting process described with reference to FIG. 13, and then the process proceeds to the step S1404.

In the step S1404, the system controller 101 determines whether or not notification of a change in files, such as update, addition, and deletion of a file, is received from any of the other image forming apparatus 15 and the information processing apparatuses 20, 25, and 30. Then, if the system controller 101 determines that such a notification has been received, the process proceeds to a step S1405, whereas if not, the process proceeds to a step S1408.

In the step S1405, the system controller 101 receives the actual data of the changed file, and the process proceeds to a step S1406. It sometimes occurs that the actual data is not received, e.g. if the actual data itself is not changed or if the associated actual data storage flag 402 is so set as not to store actual data of the file.

In the step S1406, the system controller 101 updates the file management information 400 based on the changes of the received actual data, and the process proceeds to a step S1407.

In the step S1407, the system controller 101 executes the actual data-deleting process described with reference to FIG. 13, and the process proceeds to the step S1408.

In the step S1408, the system controller 101 determines whether or not a notification of being online connected is received from any of the other image forming apparatus 15 and the information processing apparatuses 20, 25, and 30. If there is received such a notification, the process proceeds to a step S1409, whereas if not, the process is immediately terminated.

In the step S1409, the system controller 101 executes an other-apparatus online state-starting process, described hereinafter, followed by terminating the present process.

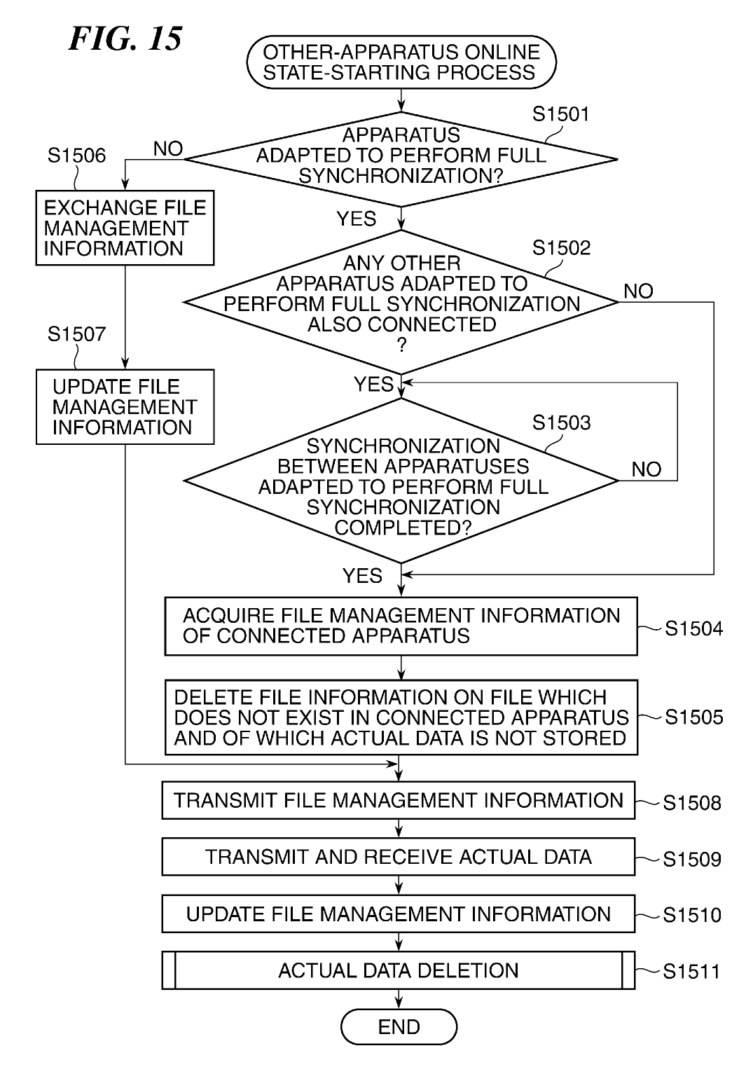

Next, a description will be given of the other-apparatus online state-starting process executed in the step S1409 in FIG. 14, with reference to FIG. 15.

First, in a step S1501, the system controller 101 determines whether an apparatus which is online connected is one (e.g. information processing apparatus 20) adapted to perform the full synchronization, or one (e.g. image forming apparatus 15) adapted to perform partial synchronization. If the apparatus is one adapted to perform the full synchronization, the process proceeds to a step S1502, whereas if the apparatus is one adapted to perform the partial synchronization, the process proceeds to a step 1506.

In the step S1502, the system controller 101 determines whether or not there is any other online-connected apparatus adapted to perform the full synchronization (e.g. information processing apparatus 25 or 30) than the aforementioned apparatus that is online connected. Then, if there is any other online-connected apparatus, the process proceeds to a step S1503, and whereas if not, the process proceeds to a step S1504.

In the step S1503, the system controller 101 determines whether or not synchronization processing on the files between the apparatuses adapted to perform the full synchronization has been completed. If the synchronization processing has not been completed, the process repeated executes the step S1503 to wait until the synchronization processing has been completed, whereas if the synchronization processing has been completed, the process proceeds to the step S1504.

In the step S1504, the system controller 101 acquires the file management information 500 of the online-connected apparatus, and the process proceeds to a step S1505.

In the step S1505, if there is a file of which actual data is not stored in the image forming apparatus 10 and at the same time of which actual data is not stored in the online-connected apparatus either, the system controller 101 deletes the associated object file information from the file management information 400 to thereby update the management information 400, and then the process proceeds to a step S1508.

On the other hand, if it is determined in the step S1501 that the online-connected apparatus is an apparatus (image forming apparatus 15) adapted to perform the partial synchronization, in the step S1506, the system controller 101 transmits and receives the file management information 400 to and from the image forming apparatus 15, and the process proceeds to a step S1507.

In the step S1507, the system controller 101 updates the file management information 400 in the image forming apparatus 10 based on the file management information 400 in the image forming apparatus 15 received in the step S1506, and the process proceeds to the step S1508.

In the step S1508, the system controller 101 transmits the updated file management information to the online-connected apparatus, and the process proceeds to a step S1509.

In the step S1509, the system controller 101 transmits and receives the actual data to and from the online-connected apparatus, as required, and the process proceeds to a step S1510.

In the step S1510, the system controller 101 updates the file management information 400 in the image forming apparatus 10 based on the results of transmission and reception of the actual data, and the process proceeds to a step S1511.

In the step S1511, the system controller 101 executes the actual data-deleting process described hereinabove with reference to FIG. 13, followed by terminating the present process.

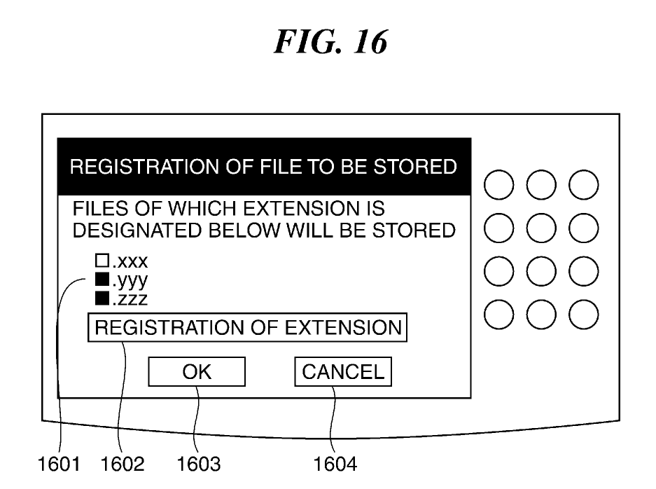

FIG. 16 is a view of an example of a screen for registering, in the image forming apparatus 10, conditions with reference to which it is determined whether or not a file is a file of which actual data does not need to be stored.

The registration screen shown in FIG. 16 is displayed on the display section 107 by display control of the system controller 101 of the image forming apparatus 10.

In FIG. 16, extension selection check boxes 1601 shows a list of extensions, and is used by the operator for selectively designating extensions via the operating section 106. The system controller 101 determines a file extension to be stored according to the state of each check box associated therewith. In the illustrated example in FIG. 16, the image forming apparatus 10 is operated to store the actual data of files having respective extensions of yyy and zzz, and not to store actual data of a file having an extension of xxx.

An extension registration button 1602 is used for performing deletion or new registration of an extension to be displayed with an extension selection check box 1601. Deletion or new registration of an extension is performed after depressing the extension registration button 1602, whereby it is possible to change the extensions displayed with the extension selection check boxes 1601.

An OK button 1603 is a button used for completing the processing after registration. The extensions designated for registration are stored in the document management section 104 of the image forming apparatus 10.

A cancel button 1604 is a button used for canceling the change on the present screen and terminating the processing.

With the above-described configuration, it becomes possible for the user to register files having proper extensions to thereby designate storage of actual data thereof, which makes it possible to improve the usability.

Further, in FIG. 16, an extension associated with a type of files which can be processed by the image forming apparatus 10 may be automatically registered by the apparatus itself, not by the user operation.

As described above, according to the present embodiment, the image forming apparatus 10 is capable of deleting actual data which does not need to be stored only in a case where the synchronization with all of the information processing apparatuses 20, 25, and 30, and the image forming apparatus 15 has been completed. This makes it possible to reduce the memory of the image forming apparatus 10, and prevent files of which actual data is not stored from being requested from the other apparatuses.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2008-232109 filed Sep. 10, 2008, which is hereby incorporated by reference herein in its entirety.

What is claimed is:

1. An image forming apparatus that is connected to a plurality of external apparatuses via a communication line, and is capable of synchronizing files with the external apparatuses, comprising:
a storage unit configured to store file management information including information on the state of synchronization with the external apparatuses;
a first determination unit configured to determine whether or not a file is a file of which actual data does not need to be stored;
a second determination unit configured to determine based on the information on the state of synchronization stored in said storage unit whether or not synchronization with all of the external apparatuses is completed; and
a first deletion unit configured to be operable when it is determined by said first determination unit that a file is a file of which actual data does not need to be stored, and at the same time it is determined by said second determination unit that synchronization with all of the external apparatuses is completed, to delete the actual data of the file which is determined to be a file of which actual data does not need to be stored.

2. The image forming apparatus according to claim 1, wherein the external apparatuses include another image forming apparatus,
the image forming apparatus further comprising:
a transmission/reception unit configured to transmit and receive file management information to and from the other image forming apparatus; and
an updating unit configured to update the file management information stored in said storage unit based on the received file management information.

3. The image forming apparatus according to claim 1, further comprising:
a third determination unit configured to determine whether or not the external apparatus which is online connected is a first apparatus which is configured not to delete actual data of each file having been synchronized;
a fourth determination unit configured to be operable when it is determined by said third determination unit that the external apparatus is the first apparatus, to determine whether or not a second apparatus which is configured not to delete actual data of each file having been synchronized, other than the first apparatus, is online connected; and
a waiting unit configured to be operable when it is determined by said fourth determination unit that the second apparatus is online connected, to wait for completion of synchronization between the first apparatus and the second apparatus.

4. The image forming apparatus according to claim 3, further comprising a second deletion unit configured to be operable when it is determined by said fourth determination unit that the second apparatus is not online connected, to delete file management information on files of which actual data is not stored, and at the same time of which the actual data is not stored in the first apparatus either.

5. The image forming apparatus according to claim 1, further comprising a registration unit configured to register conditions with reference to which said first determination unit determines whether or not a file is a file of which actual data does not need to be stored.

6. An information processing system in which an image forming apparatus and a plurality of external apparatuses are connected via a communication line, and in which the image forming apparatus and the external apparatuses are capable of synchronizing files with each other,
wherein the image forming apparatus comprises:
a storage unit configured to store file management information including information on the state of synchronization with the external apparatuses;
a first determination unit configured to determine whether or not a file is a file of which actual data does not need to be stored;
a second determination unit configured to determine based on the information on the state of synchronization stored in said storage unit whether or not synchronization with all of the external apparatuses is completed; and
a first deletion unit configured to be operable when it is determined by said first determination unit that a file is a file of which actual data does not need to be stored, and at the same time it is determined by said second determination unit that synchronization with all of the external apparatuses is completed, to delete the actual data of the file which is determined to be a file of which actual data does not need to be stored.

7. The information processing system according to claim 6, wherein the external apparatuses include another image forming apparatus,
wherein said image forming apparatus comprises:
a transmission/reception unit configured to transmit and receive file management information to and from the other image forming apparatus; and
an updating unit configured to update the file management information stored in said storage unit based on the received file management information.

8. The information processing system according to claim 6, wherein said image forming apparatus further comprises:
a third determination unit configured to determine whether or not the external apparatus which is online connected is a first apparatus which is configured not to delete actual data of each file having been synchronized;
a fourth determination unit configured to be operable when it is determined by said third determination unit that the external apparatus is the first apparatus, to determine whether or not a second apparatus which is configured not to delete actual data of each file having been synchronized, other than the first apparatus, is online connected; and
a waiting unit configured to be operable when it is determined by said fourth determination unit that the second apparatus is online connected, to wait for completion of synchronization between the first apparatus and the second apparatus.

9. The information processing system according to claim 8, wherein said image forming apparatus further comprises a second deletion unit configured to be operable when it is determined by said fourth determination unit that the second apparatus is not online connected, to delete file management information on files of which actual data is not stored, and at the same time of which the actual data is not stored in the first apparatus either.

10. The information processing system according to claim 6, wherein said image forming apparatus further comprises a registration unit configured to register conditions with reference to which said first determination unit determines whether or not a file is a file of which actual data does not need to be stored.

11. A method of controlling an image forming apparatus that is connected to a plurality of external apparatuses via a communication line, and is capable of synchronizing files with the external apparatuses, comprising:
a first determination step of determining whether or not a file is a file of which actual data does not need to be stored;
a second determination step of determining based on the information on the state of synchronization whether or not synchronization with all of the external apparatuses is completed; and
a first deletion step of deleting, when it is determined in said first determination step that a file is a file of which actual data does not need to be stored, and at the same time it is determined in said second determination step that synchronization with all of the external apparatuses is completed, the actual data of the file which is determined to be a file of which actual data does not need to be stored.

12. A computer-readable storage medium storing a program for causing a computer to execute a method of controlling an image forming apparatus that is connected to a plurality of external apparatuses via a communication line, and is capable of synchronizing files with the external apparatuses,
wherein the method comprises:
a first determination step of determining whether or not a file is a file of which actual data does not need to be stored;
a second determination step of determining based on the information on the state of synchronization whether or not synchronization with all of the external apparatuses is completed; and
a first deletion step of deleting, when it is determined in said first determination step that a file is a file of which actual data does not need to be stored, and at the same time it is determined in said second determination step that synchronization with all of the external apparatuses is completed, the actual data of the file which is determined to be a file of which actual data does not need to be stored.
